(19) United States
(12) Patent Application Publication
(10) Pub. No.: US 2006/0166639 A1
(43) Pub. Date: Jul. 27, 2006

(54) Superheterodyne circuit with band-pass filter for channel selection

(76) Inventors: Andreas Kaiser, Villeneuve (FR); Olivier Billoint, Chelles (FR); Dimitri Yurievitch Galayko, Lille (FR); Bernard Legrand, Lille (FR)

Correspondence Address: YOUNG & THOMPSON, 745 SOUTH 23RD STREET, 2ND FLOOR, ARLINGTON, VA, 22202, US

(21) Appl. No.: 10/506,163

(22) PCT Filed: Feb. 21, 2003
(86) PCT No.: PCT/FR03/00586

§ 371 Date: Jul. 26, 2005

(30) Foreign Application Priority Data
Mar. 1, 2002 (FR) 02/02658

(51) Int. Cl. H04B 1/16

(52) U.S. Cl. 455/339; 455/336

(57) ABSTRACT

A superheterodyne circuit includes at least one reception input, at least one production output wherefrom can be produced a baseband signal and at least one band-pass filter for channel selection interposed in the signal path between the input and the output. The filter is adapted to be connected to elements for measuring a characteristic frequency of signal passage in the filter, controllable shifting elements for frequency shift are arranged in the signal path, and control elements are provided, connected to the measuring elements and controlling the shifting elements with a supplementary signal, which compensates the difference of the measured characteristic frequency relative to a prescribed characteristic frequency value of the filter passage and whereof the frequency is determined based on the position of the path of the shifting elements relative to the filter.

The invention relates to a superheterodyne circuit.

A field of application of the invention concerns radiofrequency communication systems. Superheterodyne circuits normally comprise a bandpass filter for channel selection interposed in the signal path between an input for receiving a first signal and an output for producing a second signal, from which a baseband signal can be produced.

The filter is arranged to permit the passage of an intermediate frequency of the superheterodyne circuit.

Thus, the centre frequency passed by the filter must remain constant in order to enable the circuit to operate correctly. One or more other stages having intermediate frequencies may be provided upstream and/or downstream of the stage in which the filter is provided. Since the intermediate frequencies of those stages are determined as a function of one another in order to obtain the baseband signal, any drift in the centre frequency of the filter has detrimental repercussions on the baseband signal obtained.

Many of the channel-selection filters used have a drift in their centre passage frequency.

The document “An Accurate Center Frequency Tuning Scheme for 450 kHz CMOS Gm-C Bandpass Filters”, IEEE Journal of Solid-State Circuits, volume 34, no. 12, December 1999, pages 1691 to 1697, of Hiroshi Yamasaki, Kazuaki Oishi and Kunihiko Gotoh, describes a method for stabilising the centre frequency of an active bandpass filter of second intermediate frequency, in which the centre frequency of the filter is measured by observing its response to a step and the centre passage frequency of the filter is corrected by varying the transconductances of the synthesis operational amplifiers of the filter, as a function of the measurement.

This method of stabilising the centre frequency of the bandpass filter is limited to active filters comprising adjustment parameters and is therefore not suitable for all types of filter. In addition, this method is complicated to implement.

In order to stabilise the resonant frequency of micromechanical resonators having high quality factors, the document “Microresonator Frequency Control and Stabilization Using an Integrated Micro Oven”, The 7th International Conference on Solid-State Sensors and Actuators, 1999, de Clark T.-C. Nguyen and Roger T. Howe, pages 1040 to 1043 teaches adjustment of the frequency of the resonator by changing its temperature by means of heating resistors, the frequency of the resonator changing as a function of the temperature.

This method is technologically complex and unwieldy and requires thermal insulation of the resonator in order to avoid energy losses, which is also complicated and expensive.

The document “Mechanically Temperature-Compensated Flexural-Mode Micromechanical Resonators”, technical digest of IEDM-2000, pages 399 to 402, Wan-Thai Hsu, John R. Clark, and Clark T.-C. Nguyen, describes a micromechanical resonator having a mechanical structure designed to generate stresses acting against frequency shifts caused by the temperature, necessitating major modifications to the manufacturing technology.

The solutions recommended by the above-mentioned documents do not provide entirely satisfactory stabilisation of the centre passage frequency of the filter or the resonator. In addition, for the same type of filter, the centre frequency of the filter may be different from one filter sample to another under identical conditions owing to the variation in manufacture.

The object of the invention is to obtain a superheterodyne circuit which overcomes the disadvantages of the prior art and which permits the use of a channel-selection filter having a frequency drift.

To that end, the invention relates to a superheterodyne circuit comprising at least one input for receiving a first signal, at least one output for producing a second signal, from which a baseband signal can be produced, and at least one bandpass filter for channel selection, interposed in the signal path between the reception input and the production output, characterised in that the bandpass filter for channel selection is suitable for being connected to means for measuring a characteristic signal passage frequency of the bandpass filter for channel selection, controllable frequency shift means are located in the signal path, and control means are provided which are connected to the measuring means and which control the frequency shift means in order to shift the at least one signal present in the said path by an additional signal, which compensates for the deviation of the measured characteristic frequency, provided by the measuring means, relative to a prescribed characteristic passage frequency value of the bandpass filter for channel selection, the frequency of the additional signal being determined as a function of the position in the signal path of the frequency shift means relative to the bandpass filter for channel selection.

Thanks to the invention, any frequency drift of the filter, irrespective of whether it is of mechanical, thermal or electrical origin, can be compensated for in the circuit.

Thus, the circuit adapts itself to any variations that may occur in the passage frequency of the filter. There is therefore no need to intervene directly on the filter itself in order to ensure that its passage frequency is always equal to the prescribed value.

Consequently, the invention can be adapted to all types of bandpass filters and in particular non-ideal filters, and permits the use in particular of filters having high quality factors which may be relatively unstable in frequency at maximum gain.

The invention will be better understood in the light of the following description which is given purely by way of non-limiting example with reference to the appended drawings in which:

FIG. 1 is a block diagram of the circuit according to the invention;

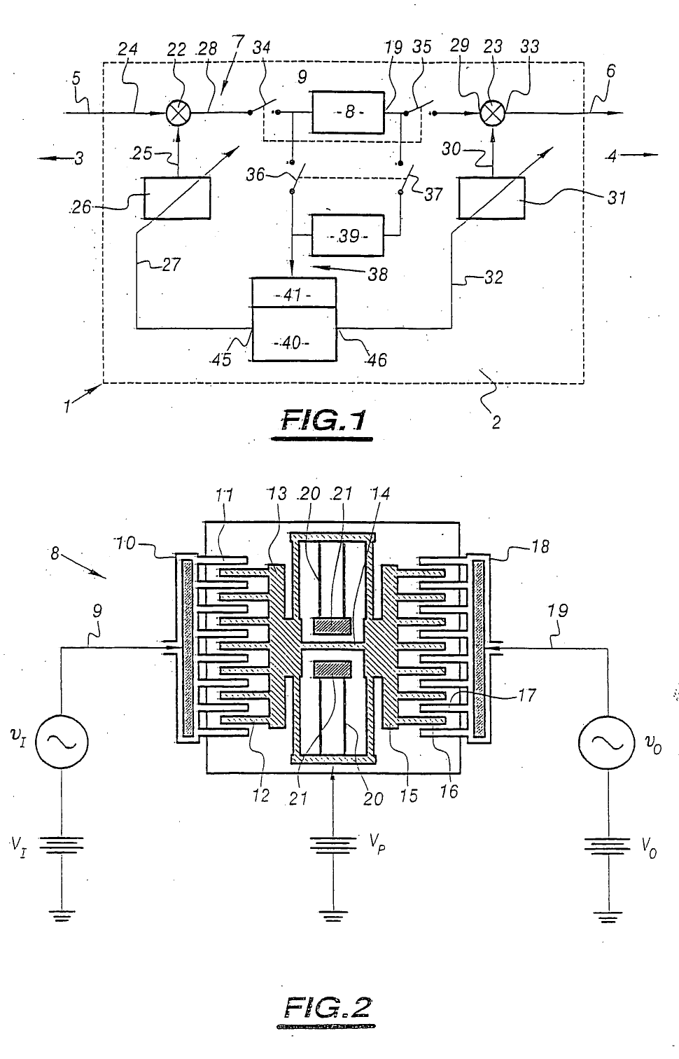

FIG. 2 shows diagrammatically a micromechanical filter that can be used in the circuit according to the invention;

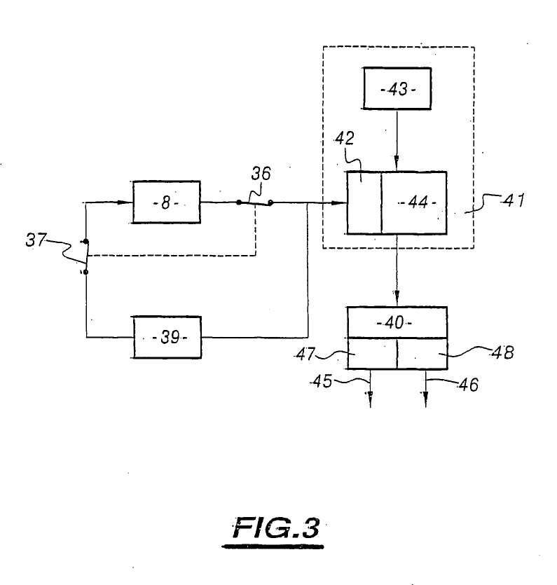

FIG. 3 is a block diagram of the control and measuring means used in the circuit according to the invention.

In FIG. 1, the superheterodyne circuit 1 forms part of a superheterodyne receiver (not shown) comprising, for example, a reception antenna. The superheterodyne circuit 1 comprises one or more stages at an intermediate frequency and, for example, as shown, a stage 2 which is at a second intermediate frequency and which is connected between an upstream first stage 3 at a first intermediate frequency and a downstream baseband stage 4. Of course, one or more stages at an intermediate frequency could also be provided downstream of stage 2. The superheterodyne circuit 1 comprises an input 5 for receiving a first signal, which is in fact the output signal of stage 3 at a first intermediate frequency, and an output 6 for producing a second signal, which is in fact the baseband input of the baseband stage 4. A signal path 7 is provided between the input 5 and the output 6.

The value of the first intermediate frequency applied to the input 5 is, for example, 10.7 MHz, for a receiver operating in the ISM band at a radiofrequency of 433.92 MHz. The portion of the receiver receiving the radiofrequency signal and converting it into the first intermediate frequency upstream of stage 2 is produced in accordance with conventional heterodyne architecture, comprising, for example, an antenna filter which is not shown.

A bandpass filter 8 for channel selection is provided in the path 7 between the input 5 and the output 6. This filter 8 is, for example, a micromechanical filter of the comb resonator type according to FIG. 2 and as described by the document “Micromechanical Resonators for Oscillators and Filters”, of Clark T.-C. Nguyen, Proceedings of the 1995 IEEE International Ultrasonics Symposium, Seattle, Wash., pages 489 to 499, 7-10 Nov. 1995, shown in FIG. 2 of that document. This filter is manufactured by epitaxied thick layer technology with a single structural layer of silicon and a buried layer of polysilicon, which is used for biasing. The input 9 of the filter is connected to an input comb 10, between the teeth 11 of which are provided the teeth 12 of an input comb 13 of a transducer 14 which also comprises an output comb 15 whose teeth 16 are provided between the teeth 17 of a comb 18 connected to the output 19 of the filter. Means 20 for suspension relative to anchoring means 21 are provided for the transducer 14. Direct voltages V_{I}, V_{O} and V_{P} are provided to bias the input 9, the output 19 and the transducer 14, respectively. The resonant frequency of this resonator is 94510 Hz at ambient temperature, the transmission bandwidth of the filter is from 2 Hz to 30 Hz as a function of the air pressure under which the resonator operates, the bias voltage in normal operation is of the order of from 40 to 60 volts. The application of an alternating voltage v_{I} to the input 9 of the filter brings about, depending on the transfer function of the filter, the appearance of an alternating voltage vₒ at the output 19 of the filter 8. Of course, other filters produced by microelectromechanical technology MEMS may be used as the filter 8.

Elements provided outside the filter 8 are described hereinafter.

In FIG. 1, frequency shift means 22, 23 are provided in the signal path 7. The means 22, 23 are, for example, of the frequency mixer type. The frequency shift means 22 is provided between the input 5 and the input 9 of the filter 8. The frequency shift means 22 comprises a first signal input 24 connected to the input 5, and a second signal input 25 connected to the output of a first local oscillator 26, capable of producing at the second input 25 an additional signal having a frequency which is variable as a function of the signal sent to an input 27 for controlling the frequency thereof.

The frequency shift means 22 comprises a signal output 28 providing a time signal which is the product of the time signals present at the first and second inputs 24 and 25 of the frequency shift means 22.

Consequently, a signal having a frequency equal to the sum of the frequencies of the signals present at the first and second inputs 24 and 25 and a signal having a frequency equal to the difference between the frequencies of the signals present at the first and second inputs 24 and 25 are present at the output 28 of the frequency shift means 22.

Likewise, a frequency shift means 23 which is also formed, for example, by a frequency mixer, is provided between the output 19 of the filter 8 and the output 6. The frequency shift means 23 comprises a first input 29 and a second input 30 which is connected to the output of a second local oscillator 31 providing an additional frequency signal at the input 30 and comprising an input 32 for controlling the frequency of the signal provided at that input 30. The frequency shift means 23 comprises an output 33 connected to the output 6.

Switching means 34 and 35 are provided between the output 28 of the first frequency shift means 22 and the input 9 of the filter 8, and between the output 19 of the filter 8 and the first input 29 of the second frequency shift means 23, respectively. Switching means 36, 37 are provided in order to connect the filter 8 to means 38 for measuring the characteristic signal passage frequency of the filter 8. The switching means 36, 37 are, for example, connected to the input 9 and to the output 19 of the filter 8, on the one hand, and to the terminals of a positive feedback module 39 which, when the switching means 36, 37 are closed, forms a loop with the filter 8 in order to cause it to oscillate. The switching means 36, 37 are controlled in the same manner relative to each other in the closed connecting state or in the open disconnecting state, for example simultaneously, as shown by the dashes between them. Likewise, the switching means 34 and 35 are controlled in the same manner relative to each other in the closed connecting state or in the open disconnecting state, as shown by the dashes between them. Finally, the switching means 34, 35 are controlled in a reverse manner relative to the switching means 36, 37 in order to connect the filter 8 either to the signal path 7 or to the measuring means 38.

In the Figures, the switching means 34, 35, 36, 37 are each formed by an interrupter which can be actuated manually. Of course, the switching means 34 and 36 could be formed by a commutator proper for switching the input 9 either to the output 28 or to the module 39, and the switching means 35 and 37 could also be formed by a commutator proper for switching the output 19 either towards the input 29 or towards the module 39, these switches being connected to one another in order to switch simultaneously either to the output 28 and the input 29, or to the module 39.

The measuring means 38 are connected to a module 40 for controlling the inputs 27, 32 for controlling the frequency of the local oscillators 26 and 31. The measuring means 38 comprise a module 41 which determines the characteristic passage frequency of the filter 8 and which is connected to the module 39, for example, by a terminal thereof connected to the means 36. The module 41 for determining the characteristic passage frequency of the filter 8 comprises, for example, as shown in FIG. 3, a first device 42 for counting the number of oscillations produced by the filter 8, which device 42 is connected to the positive feedback module 39, and a second device 43 for counting time, for example for counting the clock cycles of a computer. The devices 43 and 44 are connected to a device 44 for calculating the frequency of the oscillations produced. For example, the measurement of the characteristic passage frequency of the filter 8 is obtained by dividing the number of oscillations of the filter 8 counted by the first counting device 42 by the time counted by the second, time-counting, device 43, the switching means 36, 37 being assumed to be closed for the counting operation, as shown in FIG. 3.

The device 44 for calculating the frequency of the oscillations produced is connected to the control means 40. The control means 40 comprise a first frequency-control output 45 connected to the input 27 for controlling the frequency of the local oscillator 26 and a second frequency-control output 46 connected to the input 32 for controlling the frequency of the local oscillator 31.

Of course, measuring means other than those described above may be provided.

The control means 40 comprises a first module 47 for calculating the control signal sent to the first frequency-control output 45 for the local oscillator 26 and a second module 48 for calculating the frequency-control signal sent to the second frequency-control output 46 for the other local oscillator 31.

The filter 8 is, for example, arranged to allow the passage of the signal having a frequency equal to the difference between the frequencies of the signals present at the first and second inputs 24, 25 of the means 22 and to attenuate with a very high attenuation factor the signal having a frequency equal to the sum of the frequencies of the signals of the first and second inputs 24, 25 of the means 22, the frequency of the signal present at the input 5 being higher than that of the signal present at the second input 25.

The characteristic passage frequency of the filter is, for example, its centre passage frequency cf of its pass-band, that is to say, half the sum of the highest and lowest cutoff frequencies at −3 dB on each side of its pass-band defined by the maximum gain profile or, for a filter having a very narrow pass-band or having a very high quality factor, its frequency at maximum gain from its input 9 to its output 19.

The baseband signal present at the output 6 is formed, for example, by the signal having a frequency equal to the frequency of the signal present at the first input 29 of the means 23, less the frequency of the signal present at the second input 30 of the means 23, the theoretical characteristic passage frequency of the filter 8 being higher than the frequency of the signal present at the second input 30 of the means 23.

In that case, the calculation module 47 is arranged to send to the input 27 for controlling the frequency of the oscillator 26, a frequency-control signal for subtracting from the frequency signal present at the output of the first oscillator 26 and at the second input 25, the algebraic deviation of the measured characteristic frequency provided by the measuring means 38 relative to a prescribed passage frequency value of the filter 8. That prescribed passage frequency value of the filter 8 is equal to the theoretical characteristic passage frequency of the filter 8, that is to say, to the characteristic passage frequency for which the filter 8 has been designed. In an ideal case, that is to say, in the absence of a frequency drift of the filter 8, the actual characteristic frequency measured by the measuring means 38 is equal to the prescribed passage frequency value and the frequency deviation is zero. For a baseband output 6, the frequency of the signal present at the second input 30 is equal, in an ideal case, to the prescribed passage frequency value of the filter.

Thus, any drift in the actual characteristic passage frequency of the filter 8 is compensated for in advance by a corresponding frequency shift at its input 9, when the latter is connected by the means 34 to the output 28 of the frequency shift means 22.

In an opposite manner, the second calculation module 48 is arranged to send to the input 32 for controlling the frequency of the oscillator 31 a frequency-control signal for adding to the frequency of the signal present at the first input 29 of the second frequency shift means 23, the algebraic deviation of the measured characteristic frequency provided by the measuring means 38 relative to the prescribed passage frequency value of the filter 8.

Thus, the frequency drift which may be present in the filter 8 is eliminated from the signal having a frequency equal to the difference between the frequencies of the signals present at the inputs 29 and 30 of the frequency shift means 23, and therefore at the baseband output 6, by a corresponding frequency shift upstream of the output 6, when the latter is connected by the means 35 to the output 19 of the filter 8.

Thus, the frequency drift which may be present in the filter 8 does not have any effect on the baseband output 6, while at the same time allowing to be passed to the output 6 the information which is contained in the signal present at the input 5 and in the upstream stages and which is provided in order to be frequency-coded in a manner corresponding to the theoretical characteristic passage frequency of the filter 8, thus preventing the information transmitted to the output 6 from being impaired by the filter 8.

If a filter 8 having a transmission bandwidth of from 10 Hz to 20 Hz is used, the characteristic frequency must be determined by the means 38 with an absolute error that does not exceed 1 Hz. This is therefore also the precision with which the centre frequency of the filter must be determined.

Theoretically, in order to measure a frequency of the order of 100 kHz with a precision of 1 Hz, the number of pulses which must be received by the device 42 is 2000 (this value depends on the precision with which the device 43 measures a time interval, which depends on its operating frequency). Thus, the measuring time necessary is 20 milliseconds.

The oscillators 26, 31 are each formed, for example, by a local resonator. In order to adapt the frequency of the local resonator to the changes in the centre frequency of the filter 8, it is necessary to control its value with a precision of 1 Hz. Given that this frequency is of the same order as the first intermediate frequency (10.7 MHz), the rate of change necessary is 0.00001% of the absolute value of the frequency. Since this precision is difficult to attain by using in the oscillator 26 or 31 a phase-locked loop (PLL), the signal of the local oscillator has been generated with a direct digital synthesis DDS. The advantage of a DDS over a PLL is its capacity to generate high frequencies with very great precision.

In order to test the circuit produced, the inventors varied the temperature of the filter and thus caused its centre frequency to drift by −400 Hz. The measurements proved that the correction to the centre frequency of the filter was made with sufficient precision, the second intermediate frequency always coinciding with the centre frequency of the filter. The duration of the measuring phase is 143 ms. Although that value appears high in a real RF system (during this period reception cannot take place), it must nevertheless be borne in mind that the targeted centre frequency of micromechanical filters in the intermediate frequency stages is of the order of approximately one hundred megahertz, which requires a much shorter measuring time.

For a frequency drift that is constant over time, the filter 8 is switched by the means 34 to 37 to the measuring means 38 in order to obtain therefrom a measurement during a preliminary calibration phase, then the filter 8 is switched to the path 7, the input 5 and the output 6, in order to transmit the information contained at the input 5 to the output 6, during a reception phase.

For a frequency drift that is variable over time, or for greater reliability of the circuit, the filter 8 is periodically switched to the measuring means in order each time to adjust the frequency of the oscillators 26, 31 and the frequency correction in the path 7 for the immediately following reception phase, control means for periodic switching being provided for the purpose.

The communication means 34 to 37 may be formed by electronic interrupters which are controlled manually or automatically when the circuit is switched on.

The circuit thus adapts itself automatically to the frequency drift of the filter used, regardless of the origin of that drift and regardless of the bandpass filter for channel selection. The invention thus permits the use of the micromechanical filters mentioned above, which have the advantage of being very frequency-selective, and of making the circuit in which they are used insensitive to the instability of their centre frequency. Thus, the cost of manufacturing the filtering devices is considerably reduced. Tolerance of errors in the centre frequency which are caused by manufacture can be increased, the architecture being adapted automatically to the filter regardless of the error in its centre frequency in the range of frequencies controlled.

1. Superheterodyne circuit, comprising at least one input (5) for receiving a first signal, at least one output (6) for producing a second signal, from which a baseband signal can be produced, and at least one bandpass filter (8) for channel selection, interposed in the signal path (7) between the reception input (5) and the production output (6), characterised in that the bandpass filter (8) for channel selection can be connected to means (38) for measuring a characteristic signal passage frequency of the bandpass filter (8) for channel selection, controllable frequency shift means (22, 23) are located in the signal path (7), and control means (40) are provided which are connected to the measuring means (28) and which control the frequency shift means (22, 23) in order to shift the at least one signal present in the signal path (7) by an additional signal, which compensates for the deviation of the measured characteristic frequency, provided by the measuring means (38), relative to a prescribed characteristic passage frequency value of the bandpass filter (8) for channel selection, the frequency of the additional signal being determined as a function of the position in the signal path (7) of the frequency shift means (22, 23) relative to the bandpass filter (8) for channel selection.

2. Superheterodyne circuit according to claim 1, characterised in that the bandpass filter (8) for channel selection is micromechanical.

3. Superheterodyne circuit according to claim 2, characterised in that the bandpass filter (8) for channel selection is of the comb resonator type.

4. Superheterodyne circuit according to claim 1, characterised in that the frequency shift means (22, 23) comprise at least one frequency shift means (22) arranged upstream of the bandpass filter (8) for channel selection in the signal path (7) from the reception input (5) to the production output (6), the control means (40) controlling the frequency shift means (22) to subtract from the frequency of the signal present on the signal path (7) between the reception input (5) and the bandpass filter (8) for channel selection the deviation of the measured characteristic frequency provided by the measuring means (38) relative to the prescribed characteristic passage frequency value of the bandpass filter (8) for channel selection.

5. Superheterodyne circuit according to claim 1, characterised in that the frequency shift means (22, 23) comprise at least one frequency shift means (23) located downstream of the bandpass filter (8) for channel selection in the signal path (7) from the reception input (5) to the production output (6), the control means (40) controlling the frequency shift means (23) to add to the frequency of the signal present on the signal path (7) between the bandpass filter (8) for channel selection and the production output (6) the deviation of the measured characteristic frequency provided by the measuring means (38) relative to the prescribed characteristic passage frequency of the bandpass filter (8) for channel selection.

6. Superheterodyne circuit according to claim 1, characterised in that the frequency shift means (22, 23) comprise at least one frequency mixer (22, 23) of an intermediate frequency stage of a superheterodyne receiver.

7. Superheterodyne circuit according to claim 5, characterised in that the frequency shift means (23) downstream of the bandpass filter (8) for channel selection is suitable for producing a baseband signal at the production output (6).

8. Superheterodyne circuit according to claim 1, characterised in that the input (5) for receiving the first signal is connected to the output of an intermediate frequency stage (3) of a superheterodyne receiver.

9. Superheterodyne circuit according to claim 1, characterised in that the frequency shift means (22, 23) each comprise at least one frequency mixer (22, 23) between the signal present on the signal path (7) and the frequency signal provided by a local oscillator (26, 31) whose frequency is controlled by the control means (40).

10. Superheterodyne circuit according to claim 9, characterised in that the local oscillator (26, 31) is produced by direct digital synthesis of the DDS type.

11. Superheterodyne circuit according to claim 1, characterised in that means (34, 35, 36, 37) are provided for switching the bandpass filter (8) for channel selection between either the connection to the measuring means (38) or the connection to the signal path (7) between the reception input (5) and the production output (6).

12. Superheterodyne circuit according to claim 11, characterised in that means are provided for periodically switching the switching means (34, 35, 36, 37) to the measuring means (38) for a measuring phase by those means.

13. Superheterodyne circuit according to claim 1, characterised in that the characteristic passage frequency of the bandpass filter (8) for channel selection corresponds to the centre passage frequency of the bandpass filter (8) for channel selection.

14. Superheterodyne circuit according to claim 1, characterised in that the measuring means (38) comprise a positive feedback loop (39) in parallel with the bandpass filter (8) for channel selection in order to create oscillations at the characteristic passage frequency of the bandpass filter (8) for channel selection and a device (41) for measuring the frequency of the oscillations produced.

15. Superheterodyne circuit according to claim 14, characterised in that the measuring device (41) comprises a first device (42) for counting the number of oscillations produced in the bandpass filter (8) for channel selection and a second device (43) for counting time, which are connected to a device (44) for calculating the frequency of the oscillations produced from the number of oscillations counted by the first device (42) for counting oscillations and from the time which has elapsed during the operation of counting the number of oscillations and which is provided by the second device (43) for counting time.
